(19) United States
(12) Patent Application Publication
(10) Pub. No.: US 2022/0138089 A1
(43) Pub. Date: May 5, 2022

(54) SMART TEST EXECUTOR

(71) Applicant: EMC IP Holding Company LLC, Hopkinton, MA (US)

(72) Inventors: Bella Bekker-Vernik, Herzliya (IL); Ilan Yosef, Petah Tikva (IL); Nir Harel, Moshav Kidron (IL)

(73) Assignee: EMC IP Holding Company LLC, Hopkinton, MA (US)

(21) Appl. No.: 17/085,263

(22) Filed: Oct. 30, 2020

(51) Int. Cl. G06F 11/36; G06N 20/00

(52) U.S. Cl. CPC G06F 11/3688; G06N 20/00; G06F 11/3692; G06F 11/3684

(57) ABSTRACT

A method is provided for use in a test execution system, comprising: selecting a test that is stored in a test manager; identifying one or more test configuration parameters that are associated with the test; detecting if a job uniform resource locator (URL) is available for the test; if the job URL is available, retrieving the job URL, providing the job URL to a test tool, and executing the test by using the test tool; if the job URL is not available, identifying one or more test configuration parameters that are associated with the test, mapping each of the test configuration parameters to a corresponding job parameter, generating the job URL based on any of the corresponding job parameters, providing the job URL to the test tool, and executing the test by using the test tool.

### BACKGROUND

Software testing is an investigation conducted to assess the quality of software. Software testing can be a labor-intensive process, as the testing of complex software may require the execution of hundreds and even thousands of tests. The use of automated testing platforms may help increase the efficiency at which software testing is performed.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a method is provided for use in a test execution system, comprising: selecting a test that is stored in a test manager; identifying one or more test configuration parameters that are associated with the test; detecting whether a job uniform resource locator (URL) is available for the test; if the job URL is available, retrieving the job URL, providing the job URL to a test tool, and executing the test by using the test tool; if the job URL is not available, identifying one or more test configuration parameters that are associated with the test, mapping each of the test configuration parameters to a corresponding job parameter, generating the job URL based on any of the corresponding job parameters, providing the job URL to the test tool, and executing the test by using the test tool, wherein each of the test configuration parameters includes a parameter that is supported by the test manager, and each of the job parameters includes a parameter that is supported by the test tool.

According to aspects of the disclosure, a test execution system is provided, comprising: a memory; and one or more processors operatively coupled to the memory, the one or more processors being configured to perform the operations of: selecting a test that is stored in a test manager; identifying one or more test configuration parameters that are associated with the test; detecting whether a job uniform resource locator (URL) is available for the test; if the job URL is available, retrieving the job URL, providing the job URL to a test tool, and executing the test by using the test tool; if the job URL is not available, identifying one or more test configuration parameters that are associated with the test, mapping each of the test configuration parameters to a corresponding job parameter, generating the job URL based on any of the corresponding job parameters, providing the job URL to the test tool, and executing the test by using the test tool, wherein each of the test configuration parameters includes a parameter that is supported by the test manager, and each of the job parameters includes a parameter that is supported by the test tool.

According to aspects of the disclosure, a non-transitory computer-readable medium is provided that stores one or more processor-executable instructions, which, when executed by at least one processor of a test execution system, cause the at least one processor to perform the operations of: selecting a test that is stored in a test manager; identifying one or more test configuration parameters that are associated with the test; detecting whether a job uniform resource locator (URL) is available for the test; if the job URL is available, retrieving the job URL, providing the job URL to a test tool, and executing the test by using the test tool; if the job URL is not available, identifying one or more test configuration parameters that are associated with the test, mapping each of the test configuration parameters to a corresponding job parameter, generating the job URL based on any of the corresponding job parameters, providing the job URL to the test tool, and executing the test by using the test tool, wherein each of the test configuration parameters includes a parameter that is supported by the test manager, and each of the job parameters includes a parameter that is supported by the test tool.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a test execution system, according to aspects of the disclosure;

FIG. 2 is a diagram of an example of a test execution system, according to aspects of the disclosure;

FIG. 3A is a diagram of an example of a job parameter definition, according to aspects of the disclosure;

FIG. 3B is a diagram of an example of a job parameter, according to aspects of the disclosure;

FIG. 3C is a diagram of an example of test parameter, according to aspects of the disclosure;

FIG. 3D is a diagram of an example of a job runner, according to aspects of the disclosure;

FIG. 3E is a diagram of an example of a dictionary, according to aspects of the disclosure;

FIG. 3F is a diagram of an example of a training data set, according to aspects of the disclosure;

FIG. 3G is a diagram of an example of a test definition, according to aspects of the disclosure;

FIG. 3H is a diagram of a set of test configuration parameters, according to aspects of the disclosure;

FIG. 4 is a flowchart of an example of a process, according to aspects of the disclosure;

FIG. 5 is a flowchart of an example of a process, according to aspects of the disclosure; and

FIG. 6 is a flowchart of an example of a process, according to aspects of the disclosure.

### DETAILED DESCRIPTION

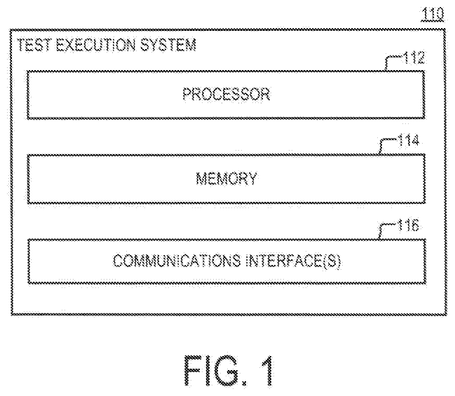

FIG. 1 is a diagram of an example of a hardware architecture of a test execution system 110. According to the example of FIG. 1, the test execution system 110 includes a processor 112, a memory 114, and a communications interface 116. The processor 112 may include any suitable type of processing circuitry, such as one or more of an integrated circuit (ASIC), a field-programmable gate array (FPGA), and/or a general-purpose processor (e.g., an ARM-based processor, an x86 processor, etc.). The memory 114 may include any suitable type of volatile and/or non-volatile memory. For example, in some implementations, the memory 114 may include one or more of random-access memory (RAM), a read-only memory (ROM), a solid-state drive (SSD), electrically erasable programmable read-only memory (EEPROM), a network-accessible storage (NAS), a redundant array of independent disks (RAID) and/or any other suitable type of memory. The communications interface(s) 116 may include a Bluetooth interface, a Wi-Fi interface, a ZigBee interface, a Universal Serial Bus (USB) interface, and/or any other suitable type of interface. Although in the example of FIG. 1 the test execution system 110 is depicted as an integrated system, it will be understood that alternative implementations are possible in which the test execution system is a distributed system, comprising a plurality of computing devices that are connected to one another via a communications network.

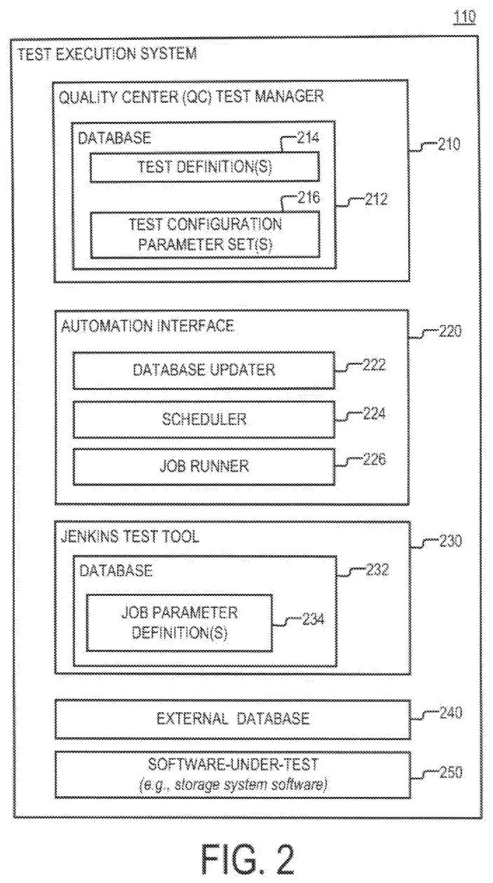

FIG. 2 is a diagram of an example of a software environment of the test execution system 110, according to aspects of the disclosure. As illustrated, the test execution system 110 may be configured to execute an instance of the Quality Center™ (QC) test manager 210, an automation interface 220, and an instance of the Jenkins™ test tool 230. Furthermore, the test execution system 110 may be configured to provide an external database 240.

QC 210 may include a suite for software quality assurance. QC 210 may include a database 212 that is configured to store a test set comprising one or more test definitions 214 and one or more sets 216 of test configuration parameters. Each of the sets 216 may correspond to a respective one of the test definitions 214. Although not shown, the database 212 may also include other information, such as information about prior test runs, job URL templates, etc. Stated succinctly, the present disclosure is not limited to any specific implementation of the database 212.

The Jenkins test tool 230 may include an automation test server configured to execute tests that are defined by the test definitions 214. The Jenkins test tool 230 may include a database 232 that is configured to store one or more job parameter definitions 234. The automation interface 220 may include a software layer that is interposed between QC 210 and the Jenkins test tool 230 for the purposes of executing, on the Jenkins test tool 230, tests that are specified by the test definitions 214. The automation interface 220 may translate the test configuration parameters, which form the test definitions 214, to corresponding job parameters that are supported by the Jenkins test tool 230. The operation of the automation interface 220 is discussed further below.

Although in the present example the test execution system 110 uses Quality Center™ as its test manager, alternative implementations are possible in which the test execution system uses another type of test manager instead. Although in the example of FIG. 2 the test execution system uses Jenkins™ as its test tool, alternative implementations are possible in which the test execution system 110 uses another type of test tool. Stated succinctly, the present disclosure is not limited to any specific test manager and/or any specific test tool being used in conjunction with the automation interface 220.

The external database 240 may include any suitable type of database, such as a MONGO™ database, a SQL database, and/or any other suitable type of database. The term “external” as used in the phrase “external database” denotes that the external database 240 is separate from the QC 210 and the Jenkins test tool 230, and it is not intended to impute any specific characteristic(s) to the external database 240. In this regard, it will be understood that the present disclosure is not limited to any specific implementation of the external database 240.

The automation interface 220 may include a database updater 222, a scheduler 224, and a job runner 226. The database updater 222 may include a process that is configured to populate the external database 240 with at least some of the contents of the database 212 and/or at least some of the contents of the database 232. The scheduler 224 may include a process that is configured to automatically schedule tests for execution according to a given schedule or priority. And the job runner 226 may include a process that is configured to execute tests that are selected by the scheduler 224. Deploying the automation interface 220 in the test execution system 110 is advantageous because it can simplify the workflow of quality assurance test running procedures for engineers and managers. In some implementations, the automation interface 220 may be configured to run tests (e.g., Jenkins jobs, etc.) without (or with minimal) human resource dependency, thereby increasing the efficiency at which software testing can be performed.

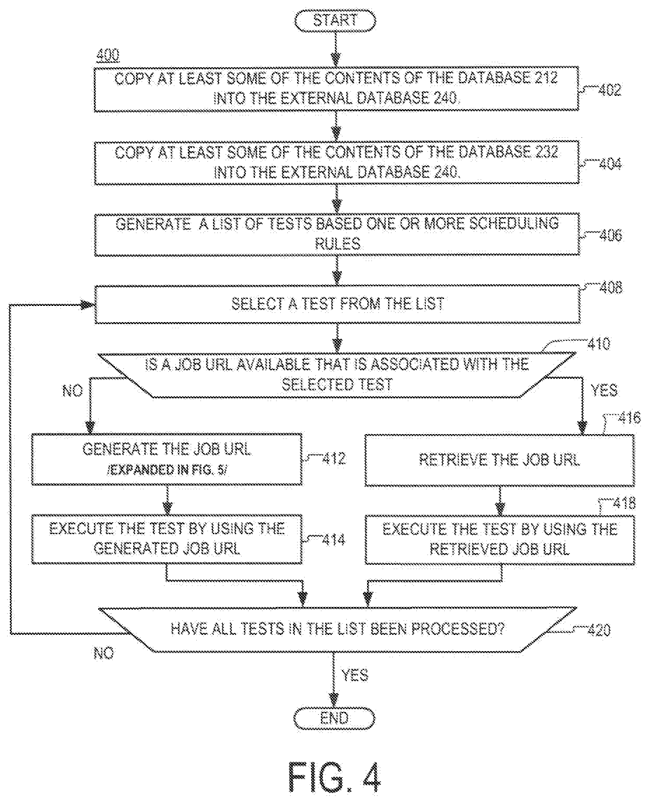

The operation of the database updater 222, the scheduler 224, and the job runner 226 is discussed in further detail with respect to FIGS. 4-6. Although in the present example, each of the database updater 222, the scheduler 224, and the job runner 226 is implemented in software, alternative implementations are possible in which any of the database updater 222, the scheduler 224, and the job runner 226 is implemented in hardware or as a combination of software and hardware.

Also depicted in FIG. 2 is a software 250, which is tested by using QC 210, the automation interface 220, and the Jenkins test tool 230. According to the example of FIG. 2, the software 250 includes software that implements a distributed storage system. However, the present disclosure is not limited to any specific type of software being tested with QC 210, the automation interface 220, and the Jenkins test tool 230. Although the software 250 is being depicted as executed on the test execution system 110, it will be understood that the software 250 can be executed on another computing system.

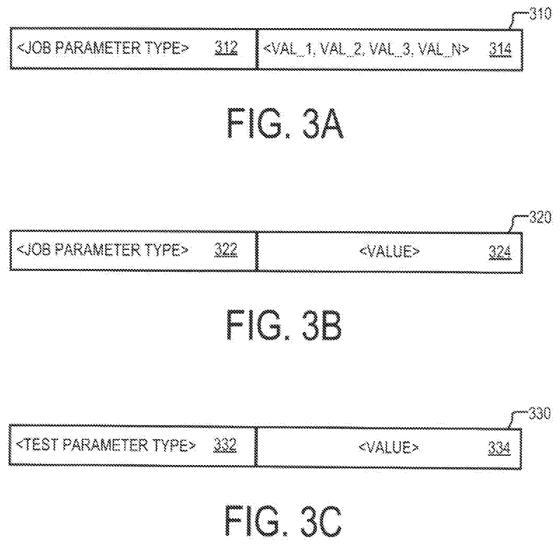

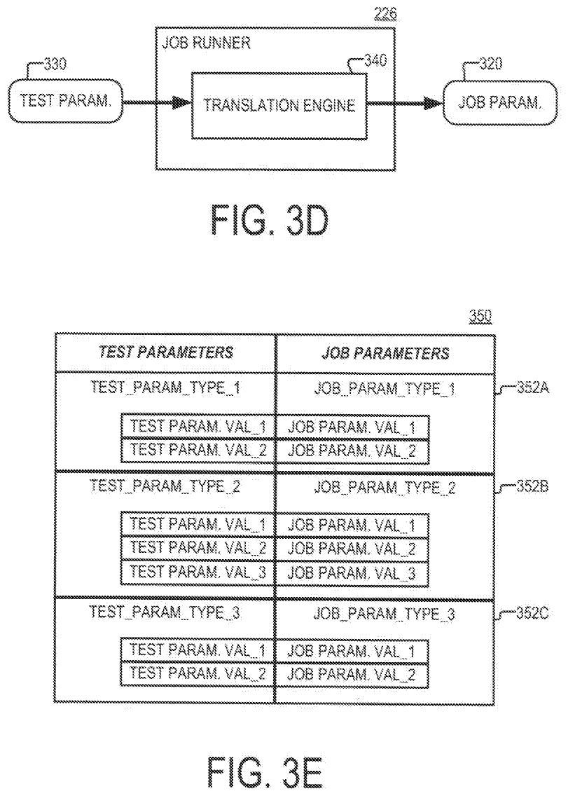

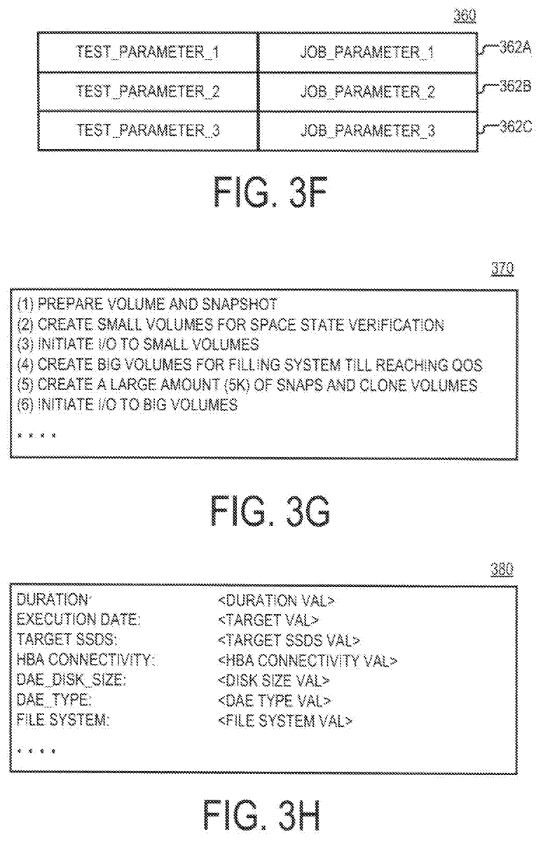

FIG. 3A is a diagram of an example of a job parameter definition 310, according to aspects of the disclosure. The job parameter definition 234 may be the same or similar to any of the job parameter definitions 234 that are stored in the database 232 (shown in FIG. 2). As illustrated, the job parameter definition may include a parameter type identifier 312 and a list 314 of one or more values that can be assumed by the parameter type. FIG. 3B shows an example of a job parameter 320. The job parameter 320 may be one that is generated by the automation interface 220 by translating a test configuration parameter that is part of any of the test definitions 214. The job parameter 320 may be the same type as the job parameter that is defined by the job parameter definition 310. As illustrated, the job parameter 320 may include a parameter type 322 and a value 324 that has been assigned to the parameter. The value 324 may be a member of the list 314. The value 324 may include any number, string, alphanumerical string, a set of numbers, a set of strings, of a set of alphanumerical strings. In some respects, FIGS. 3A and 3B illustrate that “a test configuration parameter” may include a concrete value for a particular parameter type, whereas a test configuration parameter definition may identify a set of some or all possible values that can be assumed by the parameter type.

FIG. 3C shows an example of a test configuration parameter 330 that corresponds to the job parameter 320. According to the present example, a test configuration parameter may correspond to a job parameter if translating the test configuration parameter (with the automation interface 220) yields the job parameter. As illustrated, the test configuration parameter 330 may include a parameter type 332 and a value 334 that has been assigned to the parameter. The value 334 may include any number, string, alphanumerical string, a set of numbers, a set of strings, of a set of alphanumerical strings. The job parameter 320 and the test configuration parameter 330 may have the same or different syntaxes. In some respects, the test configuration parameter 330 may include any parameter that is supported by (and/or native to) QC 210, but not by the Jenkins test tool 230. On the other hand, in some implementations, the job parameter 320 may include any parameter that is supported by (and/or native to) the Jenkins test tool 230, but not by QC 210.

FIG. 3D is a diagram of the job runner 226, according to aspects of the disclosure. As illustrated, the job runner 226 may include a translation engine 340. The translation engine 340 may be configured to receive the test configuration parameter 330 as input and generate the job parameter 320 in response. The translation engine 340 may translate the test configuration parameter 330 to the job parameter 320. In translating the test configuration parameter 330, translation engine 340 may: (i) identify a job parameter type that matches the type of the test configuration parameter; and (ii) select a value for the identified job parameter that matches the value of the test configuration parameter 330. In some implementations, the translation engine 340 may include a dictionary that matches different test configuration parameter types to corresponding job parameter types. The dictionary may also map different parameter values to corresponding job parameter values. Additionally or alternatively, in some implementations, the translation engine 340 may include a machine learning engine that is configured to receive a test configuration parameter as input and output a corresponding job parameter. The machine learning engine can be implemented by using and neural network and/or any suitable type of machine algorithm.

FIG. 3E is a diagram of an example of a dictionary 350 that can be used by the translation engine 340 to translate test configuration parameters to job parameters. As illustrated, the dictionary 350 may include a plurality of entries 352. Each entry 352 may map a respective test configuration parameter type to a corresponding job parameter type. Furthermore, each entry 352 may map a plurality of values for the entry's respective test configuration parameter type to corresponding values for the job parameter type (that is associated with the same entry). According to the example of FIG. 3E, entry 352A indicates that a first test configuration parameter type is mapped to a first job parameter type. Entry 352A further indicates that: a first value for the first test configuration parameter type is mapped to a first value for the first job parameter type; and a second value for the first test configuration parameter type is mapped to a second value for the first job parameter type. Entry 352B indicates that a second test configuration parameter type is mapped to a second job parameter type. Entry 352B further indicates that: a first value for the second test configuration parameter type is mapped to a first value for the second job parameter type; a second value for the second test configuration parameter type is mapped to a second value for the second job parameter type; and a third value for the second test configuration parameter type is mapped to a third value for the second job parameter type. Entry 352C indicates that a third test configuration parameter type is mapped to a third job parameter type. Entry 352C further indicates that: a first value for the third test configuration parameter type is mapped to a first value for the third job parameter type; and a second value for the third test configuration parameter type is mapped to a second value for the third job parameter type. Although FIG. 3E depicts the dictionary 350 as including only three entries 352, it will be understood that in practice the dictionary 350 may include a larger number of entries 352.

FIG. 3F is a diagram of an example of a data set 360 that may be used to train the translation engine 340. As illustrated, the data set 360 may include a plurality of entries 362. Each entry 362 may map a respective test configuration parameter to a corresponding job parameter. According to the present example, entry 362A maps a first test configuration parameter to a first job parameter; entry 362B maps a second test configuration parameter to a second job parameter; and entry 362C maps a third test configuration parameter to a third job parameter. Although FIG. 3C depicts the training data set as including only three entries 362, it will be understood that in practice the data set 360 may include a larger number of entries 362. The entries 362 may be generated manually and/or obtained from previous jobs that have been executed on the Jenkins test tool 230 (shown in FIG. 2).

FIG. 3G shows an example of a test definition 370, according to aspects of the disclosure. The test definition 370 may be the same or similar to any of the test definitions 214 that are discussed above with respect to FIG. 2. As illustrated, the test definition 370 may include one or more data structures (e.g., database records, files, etc.) that specify a sequence of steps that are to be performed as part of the test that is specified by the test definition 370.

FIG. 3H shows an example of a set 380 of test configuration parameters. The set 380 may be the same or similar to any of the sets 216, which are discussed above with respect to FIG. 2. As illustrated, the set 380 may include a plurality of settings that specify how the test (defined by test definition 370) is to be performed. For example, the configuration parameters may specify a duration of the test, an execution date, target solid-state drives (SSDs), a file system that is to be used for the test, etc. In some implementations, the test (defined by the test definition 370) may be associated with multiple sets of test configuration parameters.

FIG. 4 is a diagram of an example of a process 400, according to aspects of the disclosure.

At step 402, the database updater 222 copies at least some of the contents of the database 212 into the external database 240. For example, the database updater may copy at least some of the test definitions 214 and at least some of the sets 216 into the external database 240. Additionally or alternatively, in some implementations, the database updater 222 may copy one or more job URLs and job URL templates from the database 212 to the external database 240. According to the present example, a job URL template includes a URL, which has the format of job URL, but references test configuration parameters, rather than job parameters.

At step 404, the database updater 222 copies at least some of the contents of the database 232 into the external database 240. For example, the database updater 222 may retrieve the job parameter definitions 234 from the database 232 and store the retrieved job parameter definitions 234 into the external database 240.

At step 406, the scheduler 224 generates a list of the tests that are specified by the test definitions 214, which are copied from the database 212 to the external database 240. The list may be based on one or more test scheduling rules. According to the present example, the list is arranged in order of the respective priority of each of the test definitions, such as the tests with higher priority are closer to the top of the list than those with lower priority. In some implementations, the scheduler 224 may accord a higher priority to tests that have been executed least recently. Additionally or alternatively, in some implementations, the scheduler 224 may accord higher priority to tests that have failed during their last run. Additionally or alternatively, in some implementations, the scheduler 224 may assign priorities to any of the tests based on an attached ticket state that is associated with the most recent run of the same test.

At step 408, the scheduler 224 selects a test from the list. The scheduler 224 may select a test from the list that has the highest priority among all tests in the list that have not been selected yet. The scheduler may then provide the selected test to the job runner 226.

At step 410, the job runner 226 detects if a job URL is available for the test (selected at step 408). If a job URL is available, the process 400 proceeds to step 412. Otherwise, if the job URL is unavailable, the process 400 proceeds to step 416.

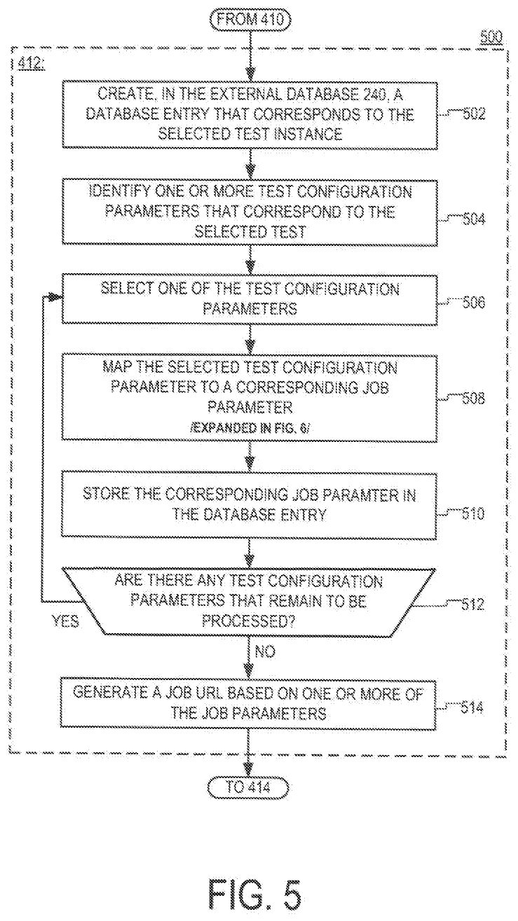

At step 412, the job runner 226 generates a new job URL for the selected test. The manner in which step 412 is performed is discussed further below with respect to FIG. 5.

At step 414, the job runner 226 executes the test based on the generated job URL. In some implementations, executing the test based on the generated job URL may include providing the generated job URL to the Jenkins test tool 230. After the job URL is provided to the Jenkins test tool 230, the Jenkins test tool 230 may use the job URL to retrieve, from the external database 240, job parameters (associated with the test) that are referenced by the job URL and use the retrieved job parameters, at least in part, as a basis for executing the test. Additionally or alternatively, in some implementations, executing the test may include providing, to the Jenkins test tool 230, the test definition 214 that corresponds to the test.

At step 416, the job runner 226 retrieves a job URL corresponding to the test definition (selected at step 408). The job URL may be retrieved from the external database 240.

At step 418, the job runner 226 executes the test based on the retrieved job URL. In some implementations, executing the test based on the generated job URL may include providing the generated job URL to the Jenkins test tool 230. After the job URL is provided to the Jenkins test tool 230, the Jenkins test tool 230 may use the job URL to retrieve, from the external database 240, job parameters (associated with the test) that are referenced by the job URL and use the retrieved job parameters, at least in part, as a basis for executing the test. Additionally or alternatively, in some implementations, executing the test may include providing, to the Jenkins test tool 230, the test definition 214 that corresponds to the test.

At step 420, the scheduler 224 determines if all tests in the list have been processed. If all tests in the list have been processed, the process 400 ends. Otherwise, if there are tests in the list that remain to be processed, the process 400 returns to step 408 and another test (which has not been selected previously) is selected.

As noted above, at step 410, the job runner 226 detects whether a job URL is available that is associated with the selected test. In some implementations, detecting whether the job URL is available may include detecting whether the test has been executed during a predetermined time period (e.g., detecting whether the test has been executed during a current test cycle). If the test has been executed during the predetermined time period, this may indicate that a job URL for the test has already been generated and is available. By contrast, if the test has not been executed during the predetermined time period, this may indicate that any job URLs that have been generated previously for the test have expired, and are no longer available to execute the test.

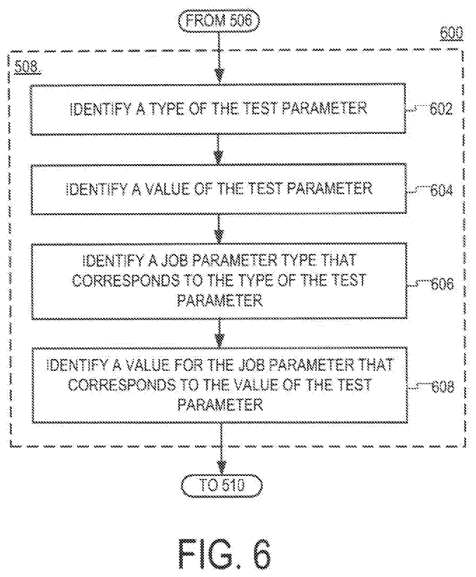

FIG. 5 is a flowchart of an example of a process 500 for generating a job URL as specified by step 412 of the process 400. At step 502, the job runner 226 creates, in the external database 240, a new entry that is intended to store job parameters for the test (selected at step 408). The new entry may include a database record and/or any other suitable type of database object or construct. At step 504, the job runner 226 identifies one or more test configuration parameters. The test configuration parameters may be part of a test configuration parameter set 216 that is associated with the test (selected at step 408). At step 506, the job runner 226 selects one of the test configuration parameters (which has not been selected previously). At step 508, the job runner 226 maps the selected test configuration parameter to a corresponding job parameter. The manner in which step 508 is performed is discussed further below with respect to FIG. 6. At step 510, the job runner 226 adds the job parameter (that is obtained at step 508) to the database entry that is created at step 502. At step 512, the job runner 226 determines if all of the test configuration parameters (identified at step 504) have been processed. If there are test configuration parameters that remain to be processed, the process 500 returns to step 506 and another one of the test configuration parameters (which has not been processed previously) is selected. At step 514, the job runner 226 generates a job URL based on one or more of the job parameters (obtained at step 508). The job URL may include any suitable type of identifier that identifies the location (in the external database 240) where the job parameters (mapped at step 508) are stored. In some implementations, generating the job URL may include retrieving from the external database 240 a pre-generated job URL template that references test configuration parameters that are associated with the test (selected at step 408), and modifying the job URL to reference the job configuration parameters (identified at step 508) instead. Additionally or alternatively, in some implementations, the job URL may reference the entry in the external database 240 (created at step 502) and it can be used to retrieve the job parameter values that have been stored in the entry.

FIG. 6 is a flowchart of an example of a process 600 for mapping a selected test configuration parameter to a corresponding job parameter, as specified by step 508 of the process 500. In some implementations, the identified job parameter type may be functionally similar (or identical) to the test parameter type. For example, both the test parameter and the job parameter may specify at least one of: test duration, HBA connectivity for the test, target SSDs, file system type for the test, etc. At step 602, the job runner 226 identifies a type of the test configuration parameter that is selected at step 506. At step 604, the job runner 226 identifies a value of the test configuration parameter that is selected at step 506. At step 606, the job runner 226 identifies a job parameter type that corresponds to the test configuration parameter type. In some implementations, the job parameter type may be identified by using the translation engine 340, which is discussed above with respect to FIG. 3D. At step 608, the job runner 226 identifies a job parameter value that corresponds to the test configuration parameter value. In some implementations, the job parameter value may be identified by using the translation engine 340, which is discussed above with respect to FIG. 3D. Additionally or alternatively, in some implementations, the translation engine 340 may use a job parameter definition 234 for the job parameter (identified at step 408) to determine what values are available for the job parameter, and select one of the available values based on the definition.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid-state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method for use in a test execution system, comprising:
selecting a test that is stored in a test manager;
identifying one or more test configuration parameters that are associated with the test;
detecting whether a job uniform resource locator (URL) is available for the test;
if the job URL is available, retrieving the job URL, providing the job URL to a test tool, and executing the test by using the test tool;
if the job URL is not available, identifying one or more test configuration parameters that are associated with the test, mapping each of the test configuration parameters to a corresponding job parameter, generating the job URL based on any of the corresponding job parameters, providing the job URL to the test tool, and executing the test by using the test tool,
wherein each of the test configuration parameters includes a parameter that is supported by the test manager, and each of the job parameters includes a parameter that is supported by the test tool.

2. The method of claim 1, wherein the test manager includes a Quality Center™ test manager, and the test tool includes a Jenkins™ test tool.

3. The method of claim 1, wherein detecting whether the job URL is available includes detecting whether the test has been executed in a current test cycle.

4. The method of claim 1, wherein mapping each of the test configuration parameters to a corresponding job parameter includes creating, in an external database, an entry including the corresponding job parameters, the entry being accessible via the job URL.

5. The method of claim 1, further comprising retrieving, from the test tool, a plurality of job parameter definitions, each of the job parameter definitions identifying a respective job parameter, and a set of values that can be assumed by the respective job parameter, wherein any of the identified test configuration parameters is mapped to at least one corresponding job parameter based on one or more of the plurality of parameter definitions.

6. The method of claim 1, wherein the mapping of each of the test configuration parameters is performed by a machine learning engine that is integrated into the test execution system.

7. The method of claim 1, further comprising generating a list of test definitions based on one or more test scheduling rules, wherein the test is selected from the list of test definitions.

8. A test execution system, comprising:
a memory; and
one or more processors operatively coupled to the memory, the one or more processors being configured to perform the operations of:
selecting a test that is stored in a test manager;
identifying one or more test configuration parameters that are associated with the test;
detecting whether a job uniform resource locator (URL) is available for the test;
if the job URL is available, retrieving the job URL, providing the job URL to a test tool, and executing the test by using the test tool;
if the job URL is not available, identifying one or more test configuration parameters that are associated with the test, mapping each of the test configuration parameters to a corresponding job parameter, generating the job URL based on any of the corresponding job parameters, providing the job URL to the test tool, and executing the test by using the test tool,
wherein each of the test configuration parameters includes a parameter that is supported by the test manager, and each of the job parameters includes a parameter that is supported by the test tool.

9. The test execution system of claim 8, wherein the test manager includes a Quality Center™ test manager, and the test tool includes a Jenkins™ test tool.

10. The test execution system of claim 8, wherein detecting whether the job URL is available includes detecting whether the test has been executed in a current test cycle.

11. The test execution system of claim 8, wherein mapping each of the test configuration parameters to a corresponding job parameter includes creating, in an external database, an entry including the corresponding job parameters, the entry being accessible via the job URL.

12. The test execution system of claim 8, wherein the one or more processors are further configured to perform the operation of retrieving, from the test tool, a plurality of job parameter definitions, each of the job parameter definitions identifying a respective job parameter, and a set of values that can be assumed by the respective job parameter, and any of the identified test configuration parameters is mapped to at least one corresponding job parameter based on one or more of the plurality of job parameter definitions.

13. The test execution system of claim 8, wherein the mapping of each of the test configuration parameters is performed by a machine learning engine that is integrated into the test execution system.

14. The test execution system of claim 8, wherein the one or more processors are further configured to perform the operation of generating a list of test definitions based on one or more test scheduling rules, and the test is selected from the list of test definitions.

15. A non-transitory computer-readable medium storing one or more processor-executable instructions, which, when executed by at least one processor of a test execution system, cause the at least one processor to perform the operations of:
selecting a test that is stored in a test manager;
identifying one or more test configuration parameters that are associated with the test;
detecting whether a job uniform resource locator (URL) is available for the test;
if the job URL is available, retrieving the job URL, providing the job URL to a test tool, and executing the test by using the test tool;
if the job URL is not available, identifying one or more test configuration parameters that are associated with the test, mapping each of the test configuration parameters to a corresponding job parameter, generating the job URL based on any of the corresponding job parameters, providing the job URL to the test tool, and executing the test by using the test tool,
wherein each of the test configuration parameters includes a parameter that is supported by the test manager, and each of the job parameters includes a parameter that is supported by the test tool.

16. The non-transitory computer-readable medium of claim 15, wherein the test manager includes a Quality Center™ test manager, and a test tool includes the Jenkins™ test tool.

17. The non-transitory computer-readable medium of claim 15, wherein detecting whether the job URL is available includes detecting whether the test has been executed in a current test cycle.

18. The non-transitory computer-readable medium of claim 15, wherein mapping each of the test configuration parameters to a corresponding job parameter includes creating, in an external database, an entry including the corresponding job parameters, the entry being accessible via the job URL.

19. The non-transitory computer-readable medium of claim 15, wherein:
the one or more processor-executable instructions, when executed by the at least one processor, further cause the at least one processor to perform the operation of retrieving, from the test tool, a plurality of job parameter definitions, each of the job parameter definitions identifying a respective job parameter, and a set of values that can be assumed by the respective job parameter, and
any of the identified test configuration parameters is mapped to at least one corresponding job parameter based on one or more of the plurality of parameter definitions.

20. The non-transitory computer-readable medium of claim 15, wherein the mapping of each of the test configuration parameters is performed by a machine learning engine that is integrated into the test execution system.
